(19) United States
(12) Patent Application Publication
(10) Pub. No.: US 2021/0127829 A1
(43) Pub. Date: May 6, 2021

(54) RACK FOR SUPPORTING COLLECTION CONTAINERS

(71) Applicant: IDETIC LLC, Chamblee, GA (US)

(72) Inventors: Will Isaac Thomason, Chamblee, GA (US); Robert Kendall Ufford, Acworth, GA (US); Hilario Alberto Urquieta, Fair Oaks Ranch, TX (US)

(21) Appl. No.: 17/257,209

(22) PCT Filed: Dec. 20, 2019
(86) PCT No.: PCT/US2019/067861

§ 371 Date: Dec. 30, 2020

Related U.S. Application Data
(60) Provisional application No. 62/783,356, filed on Dec. 21, 2018.

(51) Int. Cl. A47B 87/02; G09F 23/00; G06T 7/73; H04N 5/247

(52) U.S. Cl. CPC A47B 87/0246; H04N 5/247; G06T 7/73; G09F 23/00

(57) ABSTRACT

Disclosed are various embodiments for collection container scanning A storage rack is provided that includes a base, a pair of opposed ends connected to and extending upward from the base, and tiers connected to and extending between the ends. Each of the tiers has supports adapted for supporting collection containers A capture manager captures an image of the storage rack, and determines an individual location of one of the collection containers based on generating a decoded representation of an identifier appearing in the image. The storage rack includes a base with a recessed portion for stacking the storage rack on an identical storage rack.

### CROSS-REFERENCE TO RELATED APPLICATION

This Patent Cooperation Treaty Application claims the benefit of and priority to U.S. Provisional Patent Application No. 62/783,356 entitled “RACK FOR SUPPORTING COLLECTION CONTAINERS” filed on Dec. 21, 2018, which is expressly incorporated by reference as if fully set forth herein in its entirety.

### BACKGROUND

Specimens such as blood can be collected from a patient and stored in test tubes, vials, and other containers. A label on the container can be used to identify the container and allow the container to be matched back to the patient. Conventional approaches for scanning a container often rely on a manual scanning process which involves scanning one container at a time and then noting the location of the container within a storage rack, freezer, or the like. Such approaches can be time intensive, error prone, and may lead to difficulty storing containers and/or searching for, locating, and retrieving containers.

### SUMMARY

Disclosed herein are various systems and methods to address the aforementioned deficiencies. In various aspects, the present systems and methods can comprise one or more storage racks that can hold collection containers or other containers, including to hold the containers for scanning or to otherwise identify locations of the collection containers while they are being stored in a storage rack.

The storage rack can include a base and a pair of opposed ends connected to and extending upward from the base, and two or more tiers, rows, or other suitable protrusions, connected to and extending between the ends. One or more of the ends can include an upper portion and a lower portion, the upper portion can have a dimension (e.g., a width) that is less than the lower portion, or the upper portion and the lower portion can have some other suitable dimensional relationship.

The tiers can have supports adapted for supporting collection containers. An upper one of the tiers can have an upper stacking element formed integrally with the upper one of the tiers. A lower one of the tiers can have a lower stacking element formed integrally with the lower one of the tiers. In some examples, the lower stacking element is sized and shaped to be aligned with the upper stacking element of an identical storage rack when the storage rack is stacked on the identical storage rack. The upper stacking element can be a notch that is formed integrally with at least one of the ends. The lower stacking element can be a tab, or some other shape of protrusion, that is formed integrally with at least one of the ends. In some examples, the lower stacking element can include two tabs or other protrusions that can be aligned with the upper stacking element of the identical storage rack. Each of the tiers can include a surface adapted for displaying identifiers corresponding to the plurality of supports. In some examples, the plurality of supports of each of the tiers has a first side and a second side of supports.

The storage rack is stackable, which can mean that the storage rack can be stacked on an identical storage rack, some other rack suitable for storing collection containers, or some other device that is suitable to be stacked on (e.g., above) or stacked under (e.g., below) the storage rack. In some examples, the base of the storage rack includes a recessed portion. The recessed portion can be adapted to receive the upper one of the tiers of the identical storage rack when the storage rack is stacked on the identical storage rack, or sized and shaped to receive a portion of some other device when the storage rack is stacked on the other device. All or a portion of the storage rack can be formed integrally, so for example the pair of ends can be formed integrally with the base. In some other examples, the storage rack can be a storage rack assembly where the base, ends, etc., or portions thereof, are fastened together.

In any one or more aspects, the system(s) can include at least one computing device comprising a processor, a data store, and at least one application or manager that, when executed in the at least one computing device, causes the processor of the at least one computing device to at least capture, using at least one camera, at least one image of a storage rack. The storage rack can include two or more tiers, each of the tiers storing a collection containers at individual locations within the two or more tiers. The at least one application can determine an individual location of at least one of the collection containers based at least in part on generating a decoded representation of at least one of a plurality of identifiers appearing in the at least one image, the plurality of identifiers corresponding to each one of the individual locations. The decoded representation can for example be ASCII or non-ASCII characters corresponding to one of the plurality of identifiers.

The plurality of supports can be disposed on a first side and a second side of the storage rack. The at least one camera of the system(s) can include a first camera that obtains a first image from the first side of the storage rack, and a second camera that obtains a second image from the second side of the storage rack. In some examples, the system(s) generate the decoded representation of at least one of a plurality of identifiers appearing in the first image and the second image.

The at least one application can cause the computing device to render a user interface that displays the decoded representation in association with a representation of the individual location. The storage rack can include a surface where one or more codes or other identifiers corresponding to the supports is displayed. The application can cause the computing device to identify the storage rack based at least in part on the one or more codes appearing on the storage rack. In response to a selection of a user interface element, the application can store the decoded representation in association with the one or more codes and the individual location.

Methods of imaging, scanning, locating, and/or associating collection containers with storage racks are also provided. The methods can include capturing, using at least one camera, at least one image of a storage rack, the storage rack comprising two or more tiers, each of the tiers storing a plurality of collection containers at individual locations within the two or more tiers. The methods can also include determining an individual location of at least one of the plurality of collection containers based at least in part on generating a decoded representation of at least one of a plurality of identifiers appearing in the at least one image, the plurality of identifiers corresponding to each one of the individual locations.

Other systems, methods, features, and advantages of the present disclosure for collection container storage and/or scanning, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a perspective view of a storage rack, in accordance with various embodiments of the present disclosure.

FIG. 2 illustrates an example of a front view of a storage rack, in accordance with various embodiments of the present disclosure.

FIG. 3 illustrates an example of a top view of a storage rack, in accordance with various embodiments of the present disclosure.

FIG. 4 illustrates an example of a bottom view of a storage rack, in accordance with various embodiments of the present disclosure.

FIG. 5 illustrates an example of a side view of a storage rack, in accordance with various embodiments of the present disclosure.

FIG. 6 illustrates an example of a perspective view of a stack of storage racks, in accordance with various embodiments of the present disclosure.

FIG. 7 illustrates an example of a perspective view of a stack of storage racks, in accordance with various embodiments of the present disclosure.

FIG. 8 illustrates an example of a side view of a stack of storage racks, in accordance with various embodiments of the present disclosure.

FIG. 9 illustrates an example of a side view of a stack of storage racks, in accordance with various embodiments of the present disclosure.

FIG. 10 illustrates an example of a front view of a stack of storage racks, in accordance with various embodiments of the present disclosure.

FIG. 11 illustrates an example of a front view of a stack of storage racks, in accordance with various embodiments of the present disclosure.

FIG. 12 illustrates an example of an extendible rack, in accordance with various embodiments of the present disclosure.

FIG. 13 illustrates an example of a front view of an extendible rack, in accordance with various embodiments of the present disclosure.

FIG. 14 illustrates an example of a perspective view of an extendible rack, in accordance with various embodiments of the present disclosure.

FIG. 15 illustrates an example of a top view of an extendible rack, in accordance with various embodiments of the present disclosure.

FIG. 16 illustrates an example of a perspective view of an extendible rack, in accordance with various embodiments of the present disclosure.

FIG. 17 illustrates an example of a perspective view of an extendible rack, in accordance with various embodiments of the present disclosure.

FIG. 18 illustrates an example of a system for collection container scanning, in accordance with various embodiments of the present disclosure.

FIG. 19 illustrates an example of a storage rack as seen through a system for collection container scanning, in accordance with various embodiments of the present disclosure.

FIG. 20 illustrates an example of a bottom tier Quick Response Code (QR) scan of a storage rack as seen through a system for collection container scanning, in accordance with various embodiments of the present disclosure.

FIG. 21 illustrates an example of a top tier Quick Response (QR) scan of a rack as seen through a system for collection container scanning, in accordance with various embodiments of the present disclosure.

FIG. 22 illustrates an example of a test tube barcode scan as seen through a system for collection container scanning, in accordance with various embodiments of the present disclosure.

FIG. 23 illustrates an example of a full rack showing QRs and test tubes with barcodes as seen through a system for collection container scanning, in accordance with various embodiments of the present disclosure.

FIG. 24 illustrates an example of a full rack showing QRs and test tubes with varying barcode sizes as seen through a system for collection container scanning, in accordance with various embodiments of the present disclosure.

FIG. 25 illustrates an example method for container scanning, in accordance with various embodiments of the present disclosure.

FIG. 26 illustrates an example of a user interface that is rendered by a computer-implemented method for container scanning, in accordance with various embodiments of the present disclosure.

FIG. 27 is a schematic diagram of an example of a computing device used to implement the system of FIG. 18 in accordance with various embodiments of the present disclosure.

### DETAILED DESCRIPTION

Specimens such as blood can be stored in test tubes, vials, and other containers. A collection container can include a Quick Response (QR) code, barcode, or other identifier to identify the collection container and to allow the collection container to be matched back to a patient. For example, a patient name or unique identifier can be encoded within a Code 128 barcode (also referred to as a “128”) that is printed on a label and affixed to the outside of a test tube.

Using conventional approaches, a technician might use a scanner to scan the label on the test tube. It can be time consuming for a technician to scan multiple test tubes. The technician might also manually note a location for the test tube after scanning, such as when the technician puts the test tube in a storage rack, freezer, or the like. A manual process can allow a technician to match a test tube with a patient, but it is not a solution to the problem of quickly scanning multiple collection containers, or recording the location of multiple collection containers with a high degree of accuracy.

The present application relates to various methods, systems and apparatus for scanning of collection containers. In one example a storage rack holds multiple collection containers to allow a system to identify locations of the collection containers within the storage rack. In another example, an extendible rack can be placed on a platform to allow collection containers to be displayed in a tiered structure. In contrast to conventional approaches, the methods, systems and apparatus allow for scanning multiple collection containers. For example, the disclosed racks provide an alternative to conventional racks.

In many embodiments, the methods, systems and apparatus described herein can be used to scan a plurality of collection containers. The disclosure includes a tiered step design for supporting one or more collection containers (e.g., vials and/or collection tubes). The present disclosure provides for a storage rack of collection containers that can reduce the amount of space needed for storing and protect the collection containers, along with other benefits as can be appreciated.

The disclosed storage rack 100 features QR codes for identifying a test tube slot or location, for example a slot or location from 1 to 100. Slot ID QR codes can be located on each side of a storage rack and on each tier (also described herein as a row) of the storage rack. A middle QR code can be located on each tier that also identifies the rack ID to a capture manager of a system for scanning collection containers. The methods, systems and apparatus disclosed involve a rack that has at least two sides so that labels of collection containers facing each side can be scanned. A storage rack is disclosed herein that can be produced with two, three, four, or more tiers (or rows) of supports for collection containers.

In another embodiment, an extendible rack is disclosed. The extendible rack can be raised to a tiered step design for scanning. Two or more extendible racks can be attached to form large racks. The disclosure allows an extendible rack to be stackable, while also protecting underlying test tubes. The extendible rack features QR codes for identifying a test tube slot ID. The present embodiment includes slot ID QR codes that are on the front side of the extendible rack. A middle QR code can be located on each tier that also identifies the rack ID to a capture manager of a system for scanning collection containers. The methods, systems and apparatus disclosed involve a rack that has at least two sides so that labels of collection containers facing each side can be scanned. A storage rack is disclosed herein that can be produced with two, three, four, or more tiers of supports for collection containers. An extendible rack can also be lowered onto a platform to produce a tiered rack.

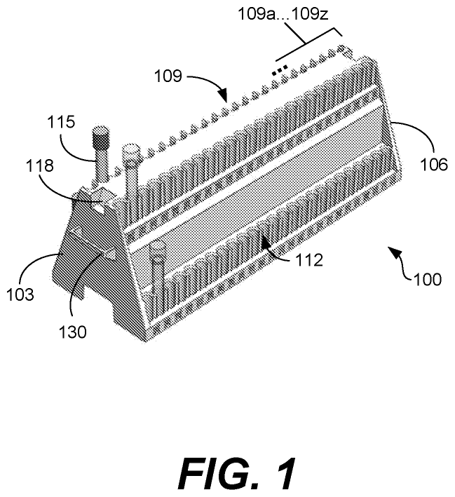

Turning to the drawings, FIG. 1 illustrates a perspective view of a storage rack 100 having two or more opposed (in some examples, identical) ends 103, 106 connected to and extending upward from a base of the storage rack 100. Two or more tiers 109, 112 are connected to and extend between the ends 103, 106. The tiers have a plurality of supports 109a . . . 109z (also referred to as slots or locations) adapted for supporting collection containers 115. The tier 109, or any upper one of the tiers 109, 112, can have an upper stacking element 118 formed integrally with the upper one of the tiers 109. A lower one of the tiers 112 can have a lower stacking element (depicted in one of the following Figures) formed integrally with the lower one of the tiers 112.

While the storage rack 100 depicted in FIG. 1 shows two tiers 109, 112, the storage rack 100 can also be produced in larger tiered steps, for example with three, four, or five tiers or rows. One of the plurality of supports 109a . . . 109z of the top tier 109 is shown as supporting a collection container 115. For example, one of the supports 109a . . . 109z can support a collection container for scanning (e.g., in an upright position).

While the present disclosure involves a storage rack 100 that is formed as one piece through additive manufacturing or some other manufacturing process, the storage rack 100 can also be formed from multiple pieces as can be appreciated by one skilled in the art.

The storage rack 100 can include an upper stacking element 118 formed integrally with the top of each one of (or one of) the ends 103, 106. The upper stacking element 118 as depicted is one of two upper stacking elements 118 of the storage rack 100. The upper stacking element 118 is configured to receive a lower stacking element of an adjacent storage rack. There is a handle 130 for lifting the storage rack 100.

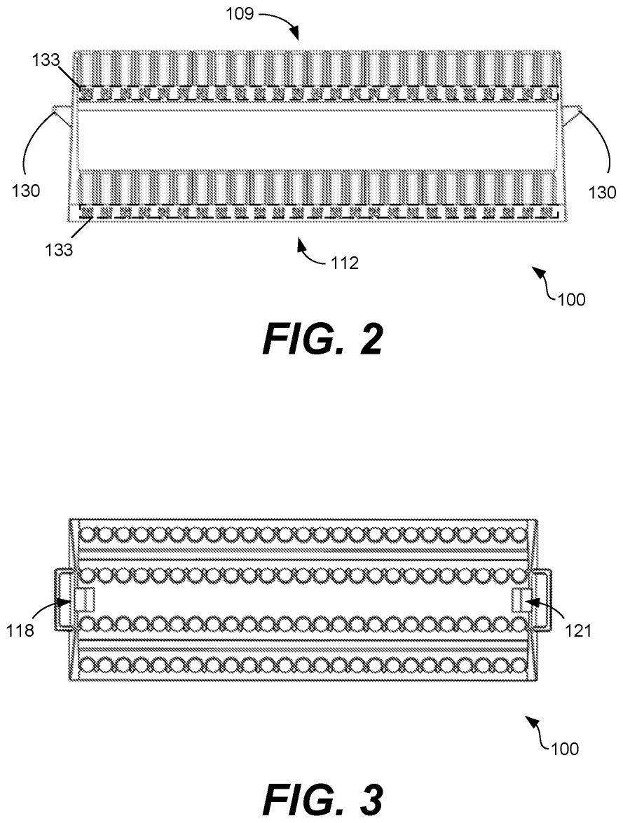

FIG. 2 illustrates a front view of a storage rack 100. Each of the tiers 109, 112 can include a surface 133 adapted for displaying identifiers corresponding to the plurality of supports (e.g., supports 109a . . . 109z depicted in FIG. 1). The storage rack 100 as depicted in FIG. 2 includes a surface 133 that includes a QR code or other identifier below one or more of the plurality of supports 109a . . . 109z (FIG. 1) to allow the support to be identified within a capture manager of a system for scanning collection containers. An identifier can also be located on one or more of the ends 103, 106, or some other suitable surface of the storage rack 100 to identify a particular storage rack 100.

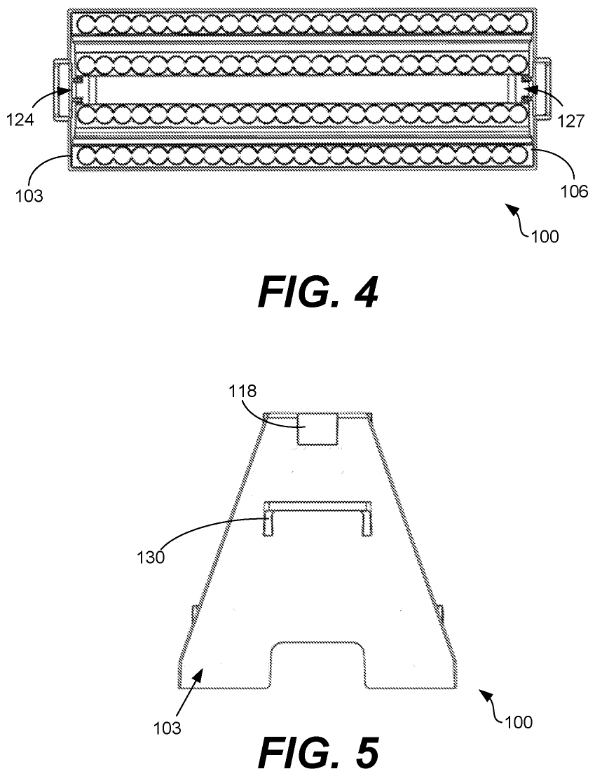

FIG. 3 illustrates a top view of a storage rack 100. The storage rack 100 can include an upper stacking element 118 formed integrally with a top of the end 103, and an upper stacking element 121 formed integrally with a top of the end 106. Each of the upper stacking elements 118, 121 is configured to receive a lower stacking element 124, 127 (FIG. 4) of an identical storage rack 100, as can be further appreciated with reference to the following.

FIG. 4 illustrates a bottom view of a storage rack 100. The storage rack 100 can include a lower stacking element 124, 127 formed integrally with a portion (e.g., bottom portion) of each one of the ends 103, 106 (FIG. 1). The storage rack 100 has a lower stacking element 124 formed integrally with the end 103, and a lower stacking element 127 formed integrally with the end 106. Each of the lower stacking elements 124, 127 is configured to be aligned with the upper stacking element of an identical storage rack 100 when the storage rack 100 is stacked on the identical storage rack 100.

FIG. 5 illustrates a side view of storage rack 100 showing a handle 130 for lifting the storage rack 100. FIG. 5 depicts an example of a side view of the end 103 and the upper stacking element 118. The storage rack 100 depicted can include an identifier (not depicted) located on any suitable surface or other portion of the end 103 to identify a particular storage rack 100.

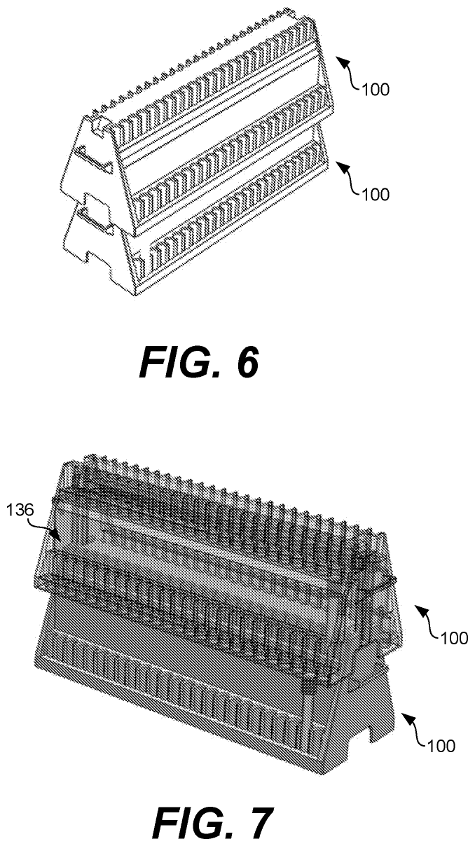

Referring now to FIG. 6, shown is a perspective view of a storage rack 100 that is stacked on an identical storage rack 100. In this example, the lower stacking element 124 (FIG. 4) has been aligned with the upper stacking element 118 (FIG. 5) of the identical storage rack 100.

FIG. 7 illustrates a perspective view of a first (or top) storage rack 100 that is stacked on a second (or bottom) storage rack 100. The illustration shows that a collection container 115 (FIG. 1) of the bottom storage rack 100 can fit within a recess, cavity, or other suitable space of the top storage rack 100. FIG. 7 illustrates that the first storage rack 100 can include a base 136 with a recessed portion. The recessed portion of the base 136 of the top storage rack 100 has received an upper one of the tiers (e.g., tier 109 as shown in FIG. 1) of the bottom storage rack 100. FIG. 7 shows a transparent view of a collection container of the bottom storage rack 100 being further supported by the base 136 of the top storage rack 100.

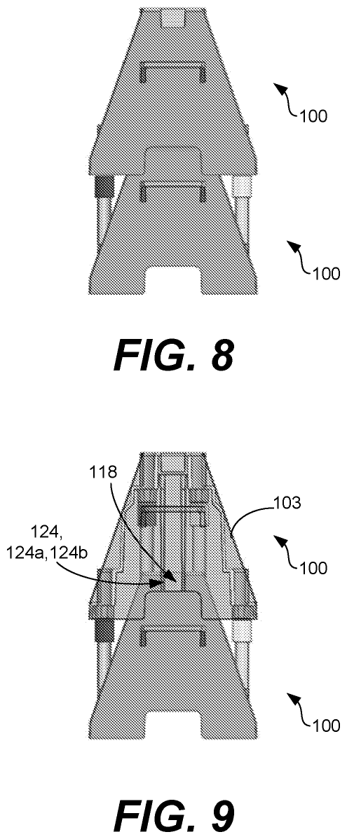

FIG. 8 illustrates a side view of a top storage rack 100 that is stacked on a bottom storage rack 100. FIG. 9 illustrates a side view of a top storage rack 100 that is stacked on a bottom storage rack 100, showing collection containers underneath. As depicted, a weight of the top storage rack 100 can be distributed, in some cases evenly, across the bottom storage rack 100. A lower stacking element 124 of the top storage rack 100 has been nestled within an upper stacking element 118 of the bottom storage rack 100. The lower stacking element 124 as depicted includes at least one tab 124a that is formed integrally with at least one of the ends 103, 106 (FIG. 1). The at least one tab 124a depicted in FIG. 7 shows two tabs 124a, 124b that can form a channel that extends along at least a portion of the ends 103, 106. In some examples, the lower stacking element 124 forms a groove that extends from near the bottom of the end 103 to near the top of the end 103.

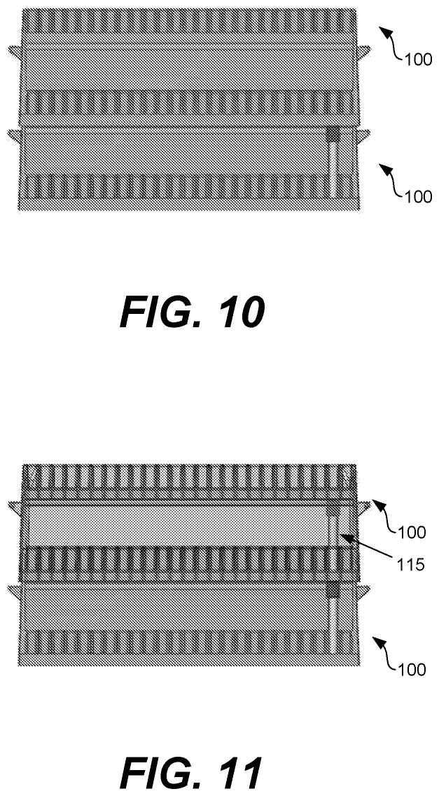

FIG. 10 illustrates a front view of a stack of storage racks 100. FIG. 11 illustrates a front view of a stack of storage racks 100 showing a collection container 115 within a recess of the base 136 of the storage rack 100 (FIG. 7).

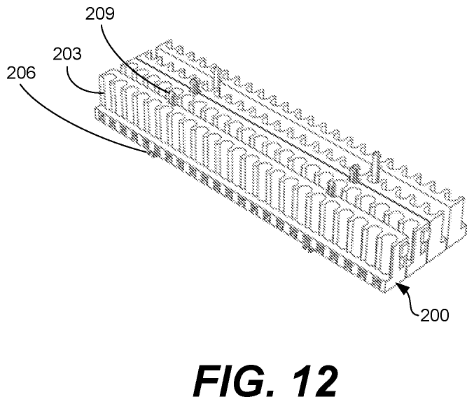

Moving on to other embodiments, FIG. 12 illustrates an example of an extendible rack 200. The extendible rack 200 has a row 203 of a plurality of supports for collection containers. The extendible rack 200 also has a front join element 206 and a rear join element 209, one or both of which can be used to join the extendible rack 200 to form a large rack. The example shows that a face of the front of the extendible rack 200 has QRs to identify slot IDs. The extendible rack 200 depicted in FIG. 12 is shown as joined together with an adjacent rack where the rear join element 209 of the extendible rack 200 has been joined with a front joint element of the adjacent rack, and where two rear join elements of adjacent racks have been joined together. In the drawing, four extendible racks 200 have been joined together.

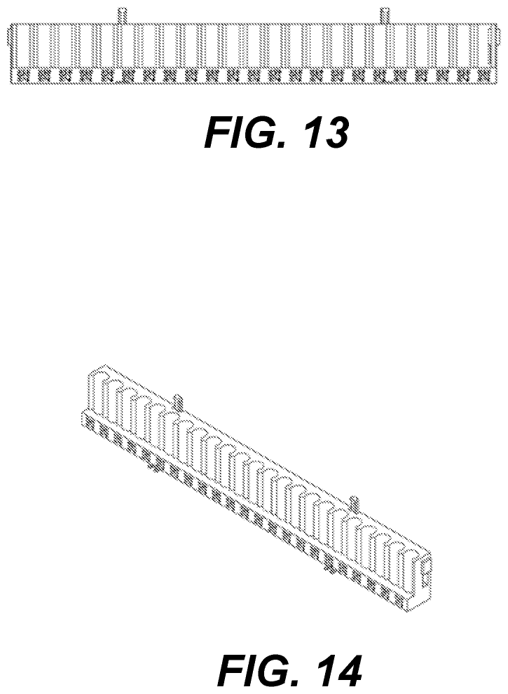

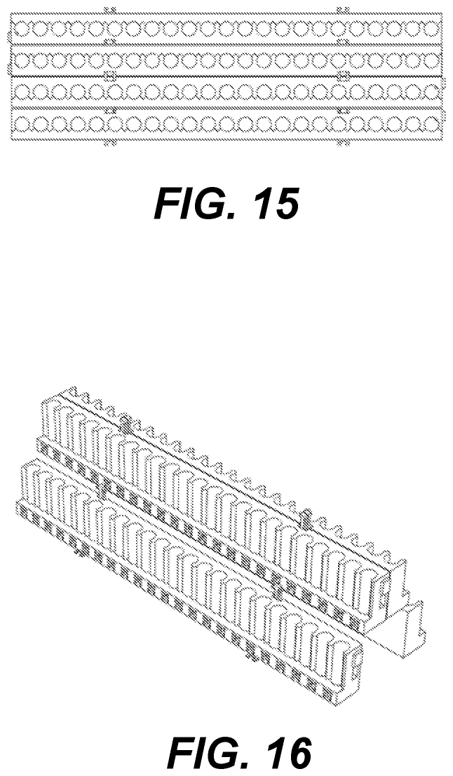

FIG. 13 illustrates an example of a front view of an extendible rack 200. FIG. 14 illustrates an example of a perspective view of an extendible rack 200. FIG. 15 illustrates an example of a top view of an extendible rack, in accordance with various embodiments of the present disclosure. FIG. 16 illustrates an example of a perspective view of an extendible rack 200. FIG. 16 also shows the ability of an extendible rack 200 to transform into tiered steps.

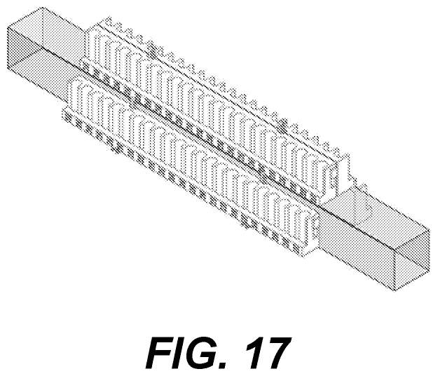

FIG. 17 illustrates an example of a perspective view of an extendible rack 200. Here the extendible rack 200 has been placed on a platform to allow the extendible rack 200 to automatically slide into tiered steps.

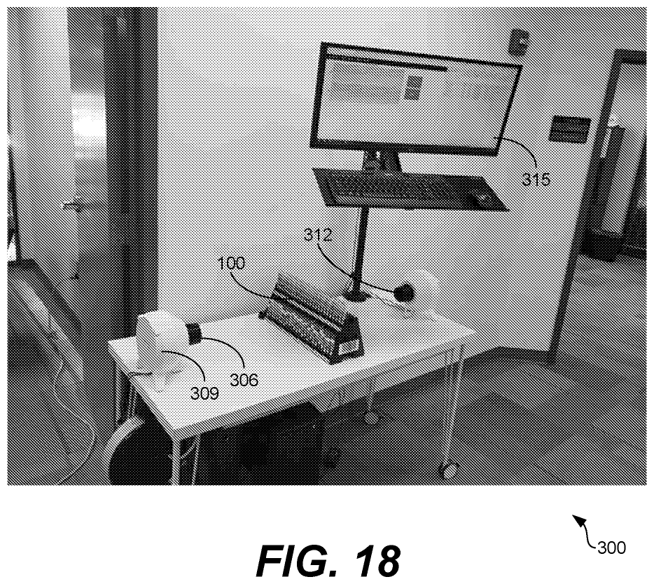

FIG. 18 illustrates an example of a system 300 for collection container scanning. The system 300 can include a storage rack 100 (or an extendible rack 200) that is configured to hold a plurality of collection containers 115 for scanning. The system 300 depicted includes a camera 306 configured to obtain at least one image of the storage rack 100. The camera 306 is housed in a housing 309.

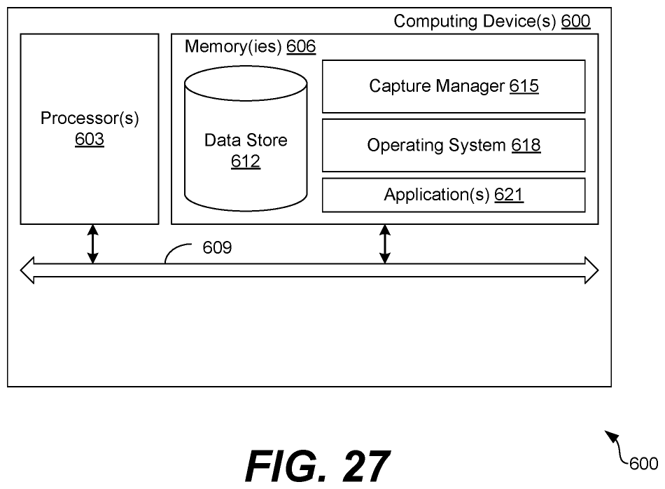

The system 300 can include a capture manager 615 (FIG. 27) configured to capture a location for the plurality of collection containers 115 that are supported by the storage rack 100. The capture manager 615 can analyze the image to identify a QR code that is associated with a slot of the storage rack 100. The capture manager 615 can also analyze the image to identify a collection container 115. Then, the capture manager 615 can identify a location 109a . . . 109z for the collection container 115. The system 300 can be used for example to identify locations 109a . . . 109z for a top group of collection containers 115 and a bottom group of collection containers 115, corresponding to the two or more tiers 109, 112, rather than requiring each collection container 115 to be scanned or identified using a manual scanning process.

Also depicted in FIG. 18, the system 300 can include a second camera 312 that obtains an image from a rear side of the storage rack 100. As can be appreciated, such a system 300 can be used for simultaneously capturing locations 109a . . . 109z for many collection containers 115. The storage rack 100 depicted for example has been used to capture locations for 100 collection containers 115 and to output the locations onto a display 315.

FIG. 19 illustrates a storage rack 100 as seen through a capture manager 615 of a system 300 (FIG. 18). The example depicted in FIG. 19 shows an image 139 of a top tier 109 and a bottom tier 112 of a storage rack 100 (as depicted in FIG. 1).

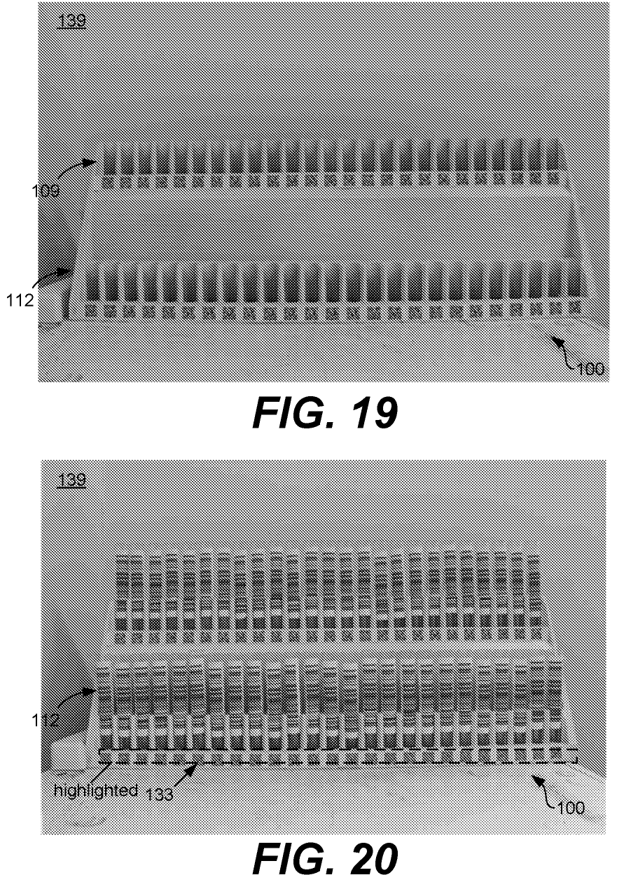

FIG. 20 illustrates an example image 139 showing a QR scan of a bottom tier 112 of a storage rack 100 as seen through a capture manager 615 (FIG. 27) of a system 300 (FIG. 18). Here, the capture manager 615 (FIG. 27) has identified a plurality of QR codes located on the surface 133 of the bottom tier 112 of the storage rack 100, and has highlighted the identifiers on the bottom tier 112.

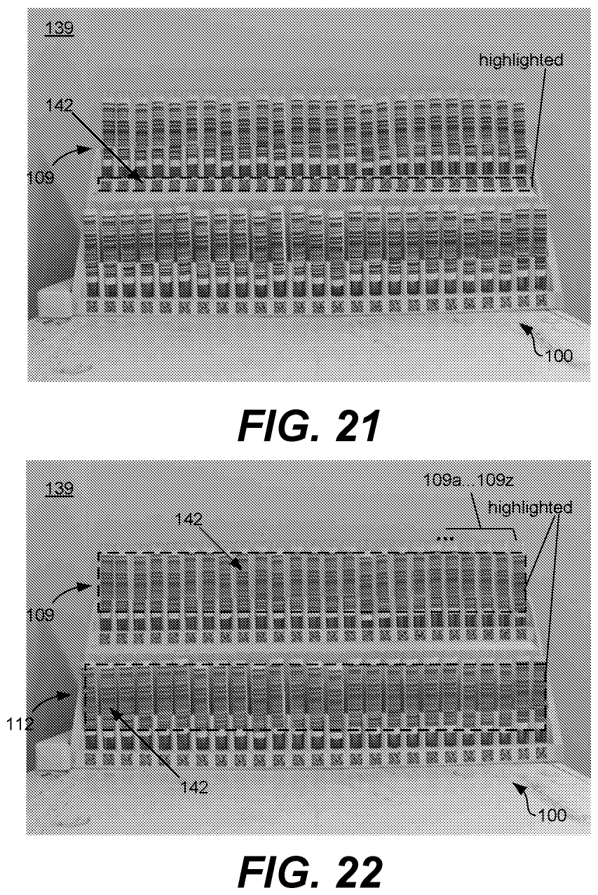

FIG. 21 illustrates an example image 139 of a QR scan of a top tier 109 of a storage rack 100 as seen through a capture manager 615 (FIG. 27) of a system 300 (FIG. 18). Here, the capture manager 615 (FIG. 27) has identified supports of the top tier 109 of the storage rack 100 and has highlighted the identifiers 142 on the top tier 109.

FIG. 22 illustrates an example image 139 of a test tube barcode scan as seen through a capture manager 615 (FIG. 27) of a system 300 (FIG. 18). Here, the capture manager 615 (FIG. 27) has identified collection containers in the supports 109a . . . 109z of the top tier 109 of the storage rack 100 and the slots of the bottom tier 112 of the storage rack 100. The capture manager 615 (FIG. 27) has highlighted the identifiers 142 on the collection containers 115 on the top tier 109 and the bottom tier 112.

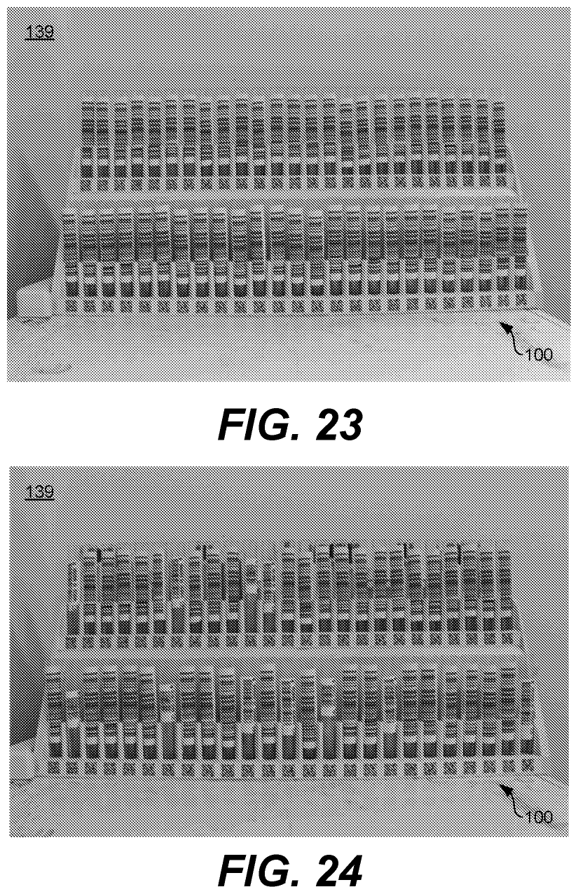

FIG. 23 illustrates an example image 139 of a storage rack 100 showing QRs and test tubes with barcodes as seen through a capture manager 615 (FIG. 27) of a system 300 (FIG. 18). FIG. 24 illustrates an example image 139 of a storage rack 100 showing QRs and test tubes with varying barcode sizes as seen through a capture manager 615 (FIG. 27) of a system 300 (FIG. 18).

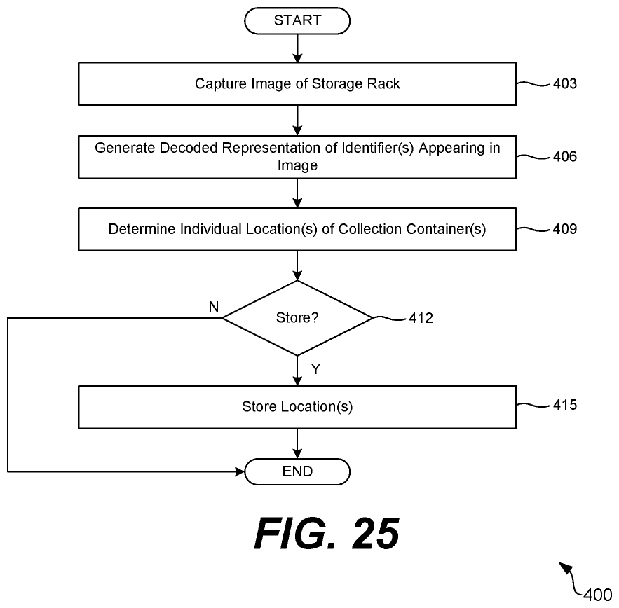

Referring next to FIG. 25, shown is a flowchart that provides one example of the operation of portions of a capture manager 615 (FIG. 27) and/or other applications according to various embodiments. It is understood that the flowchart of FIG. 25 provides merely an example of the many different types of functional arrangements that may be employed to implement the operation of the portions of the capture manager 615 (FIG. 27) and/or other applications as described herein. As an alternative, the flowchart of FIG. 25 illustrates an example method 400 for collection container scanning, including for scanning collection containers stored in a storage rack 100. The method 400 can also be seen as a computer-implemented method for a system 300 for container scanning.

At step 403, the capture manager 615 (FIG. 27) or the method 400 can capture, using at least one camera 306, 312, at least one image 139 of a storage rack 100, the storage rack comprising two or more tiers 109, 112, each of the tiers 109, 112 storing a plurality of collection containers 115 at individual locations 109a . . . 109z within the two or more tiers 109, 112. The at least one camera 306, 312 can also include a first camera 306 and a second camera 312. The capture manager 615 (FIG. 27) or the method 400 can further obtain, using the first camera 306, a first image from a first side of the storage rack 100 and obtain, using the second camera 312, a second image from a second side of the storage rack. The at least one image 139 can include the first image and the second image.

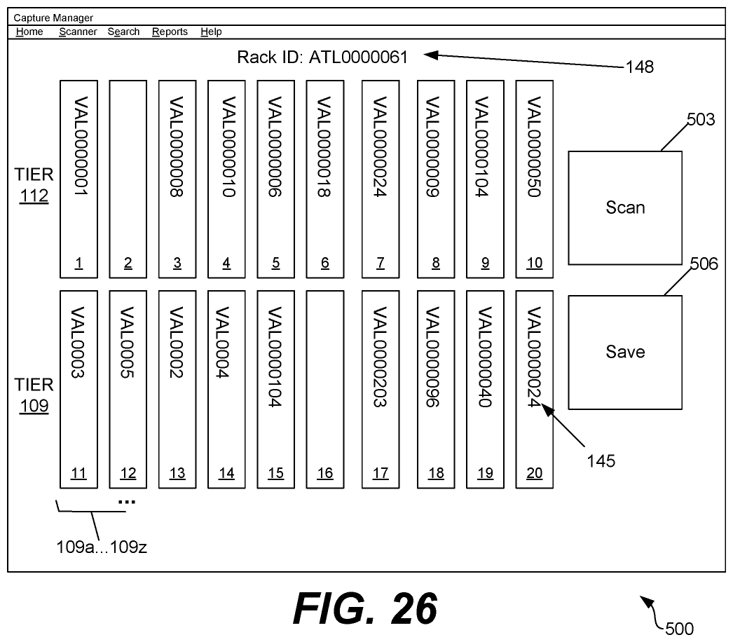

At step 406, the capture manager 615 (FIG. 27) or the method 400 can generate a decoded representation of at least one of a plurality of identifiers 142 appearing in the at least one image 139. At step 409, the method can determine an individual location 109a . . . 109z of at least one of the plurality of collection containers 115 based at least in part on the decoded representation. In some examples, the capture manager 615 (FIG. 27) or the method 400 generates the decoded representation of at least one of a plurality of identifiers 142 appearing in the first image and the second image that can be included in the at least one image 139. For example, the plurality of identifiers 142 can correspond to each one of the individual locations 109a . . . 109z. The capture manager 615 (FIG. 27) or the method 400 can identify a particular storage rack 100 based at least in part on a unique code or other identifier 142 appearing on the storage rack 100. The method 400 can also render a user interface 500 (FIG. 26) that displays the decoded representation in association with a representation of the individual location 109a . . . 109z.

At step 412, the capture manager 615 (FIG. 27) or the method 400 can determine whether to store the decoded representation in association with the individual location(s) 109a . . . 109z of collection container(s) 115, and/or in association with the unique code for the particular storage rack 100. For example, the capture manager 615 or the method 400 can obtain a selection of the user interface element 506 as shown in FIG. 26. If a user interface element is not selected, the process can proceed to completion. In response to the selection of the user interface element (FIG. 26), the capture manager 615 can proceed to step 415 where the capture manager 615 or the method 400 can store can store the decoded representation in the data store 617 (FIG. 27) in association with the unique code and the individual location(s) of collection container(s) 115. Thereafter, the method can proceed to completion.

FIG. 26 illustrates an example of a user interface 500 rendered by a computing device 600 (FIG. 27). The user interface 500 can depict a numeral (1 20, 100, etc.) and a box or other representation for each of the supports of the storage rack 100. For example, a series of numerals (e.g., 1 to 100) can be depicted when the storage rack 100 has 100 supports. The representations for the supports can be arranged corresponding to the tiers of the storage rack 100. In the depicted example, the user interface 500 represents a storage rack 100 that includes a tier 109 and a tier 112.

The user interface 500 depicted in FIG. 26 has displayed one or more decoded representations 145 in association with the representation of the individual locations 109a . . . 109z corresponding to tier 109. In addition, a decoded representation 148 depicting ASCII characters of “ATL0000061” shows that a particular storage rack 100 has been identified based at least in part on an identifier or unique code appearing on the storage rack 100 (FIG. 1). The user interface 500 can include a first user interface element 503 to capture at least one image of the storage rack 100. The user interface 500 can also include a second user interface element 506 to store decoded representation 148, one or decoded representations 145, locations, associations, or other suitable data in the data store 617 (FIG. 27).

With reference to FIG. 27, shown is a schematic block diagram of a computing device 600 that can be used to implement the system 300 of FIG. 18 according to various embodiments of the present disclosure. The computing device 600 includes at least one processor circuit, for example, having a processor 603 and a memory 606, both of which are coupled to a local interface 609. To this end, the computing device 600 may comprise, for example, at least one server computer or like device. The local interface 609 may comprise, for example, a data bus with an accompanying address/control bus or other bus structure as can be appreciated.

The computing device 600 may include an input/output device such as a display 315 (as depicted in FIG. 18). The input/output device may comprise, for example, one or more devices such as a keyboard, mouse, gesture input device, touch screen (resistive, capacitive, or inductive), microphone, liquid crystal display (LCD) display, gas plasma-based flat panel display, organic light emitting diode (OLED) display, projector, or other types of input/output device, etc.

Stored in the memory 606 are both data and several components that are executable by the processor 603. In particular, stored in the memory 606 and executable by the processor 603 may be a capture manager 615, an operating system 618, and/or other applications 621. Also stored in the memory 606 may be a data store 612 and other data. The computing device 600 can also include one or more converter(s) to interface with system cameras and/or system peripherals.

It is understood that there may be other applications that are stored in the memory 606 and are executable by the processor 603 as can be appreciated. For example, applications 621 can include software that reads barcodes from images, or other application 621 that are suitable to use as a part of a system for collection container scanning. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the capture manager 615, application(s) 621, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Although the flowchart of FIG. 25 shows a specific order of execution, it is understood that the order of execution may differ from that which is depicted. For example, the order of execution of two or more blocks may be scrambled relative to the order shown. Also, two or more blocks shown in succession in FIG. 25 may be executed concurrently or with partial concurrence. Further, in some embodiments, one or more of the blocks shown in FIG. 25 may be skipped or omitted (in favor, e.g., conventional scanning approaches). In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the capture manager 615 and/or application(s) 621, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

In addition to the foregoing, the various embodiments of the present disclosure include, but are not limited to, the embodiments set forth in the following clauses:

Clause 1. A storage rack, comprising: a base; a pair of opposed ends connected to and extending upward from the base; and two or more tiers connected to and extending between the ends, each of the tiers having a plurality of supports adapted for supporting collection containers, an upper one of the tiers having an upper stacking element formed integrally with the upper one of the tiers, a lower one of the tiers having a lower stacking element formed integrally with the lower one of the tiers, wherein the lower stacking element is adapted to be aligned with the upper stacking element of an identical storage rack when the storage rack is stacked on the identical storage rack.

Clause 2. The storage rack according to clause 1, wherein each of the tiers comprises a surface adapted for displaying identifiers corresponding to the plurality of supports.

Clause 3. The storage rack according to any of clauses 1 or 2, wherein the upper stacking element is a notch that is formed integrally with at least one of the ends.

Clause 4. The storage rack according to any of clauses 1-3, wherein the lower stacking element is at least one tab that is formed integrally with at least one of the ends.

Clause 5. The storage rack according to any of clauses 1-4, wherein the at least one tab comprises two tabs that form a channel that extends along at least a portion of the at least one of the ends.

Clause 6. The storage rack according to any of clauses 1-5, wherein the base comprises a recessed portion adapted to receive the upper one of the tiers of the identical storage rack when the storage rack is stacked on the identical storage rack.

Clause 7. The storage rack according to any of clauses 1-6, wherein the plurality of supports of each of the tiers has a first side and a second side of supports.

Clause 8. The storage rack according to any of clauses 1-7, wherein the pair of ends are formed integrally with the base.

Clause 9. The storage rack according to any of clauses 1-8, wherein each one of the ends comprises an upper portion and a lower portion, the upper portion having a width that is less than the lower portion.

Clause 10. The storage rack according to any of clauses 1-9, wherein each of the ends further comprise a handle.

Clause 11. A system for collection container scanning, comprising: at least one computing device; and at least one application executed in the at least one computing device, wherein when executed the at least one application causes the at least one computing device to at least: capture, using at least one camera, at least one image of a storage rack, the storage rack comprising two or more tiers, each of the tiers storing a plurality of collection containers at individual locations within the two or more tiers; and determine an individual location of at least one of the plurality of collection containers based at least in part on generating a decoded representation of at least one of a plurality of identifiers appearing in the at least one image, the plurality of identifiers corresponding to each one of the individual locations.

Clause 12. The system according to clause 11, wherein the at least one camera comprises a first camera configured to obtain a first image from a first side of the storage rack, and a second camera configured to obtain a second image from a second side of the storage rack, wherein the at least one image comprises the first image and the second image.

Clause 13. The system according to any of clauses 11 or 12, the at least one application further causing the computing device to render a user interface that displays the decoded representation in association with a representation of the individual location.

Clause 14. The system according to any of clauses 11-13, the at least one application further causing the computing device to identify the storage rack based at least in part on a unique code appearing on the storage rack.

Clause 15. The system according to any of clauses 11-14, the at least one application further causing the computing device to, in response to a selection of a user interface element, storing the decoded representation in association with the unique code and the individual location.

Clause 16. A computer-implemented method for collection container scanning, comprising: capturing, using at least one camera, at least one image of a storage rack, the storage rack comprising two or more tiers, each of the tiers storing a plurality of collection containers at individual locations within the two or more tiers; and determining an individual location of at least one of the plurality of collection containers based at least in part on generating a decoded representation of at least one of a plurality of identifiers appearing in the at least one image, the plurality of identifiers corresponding to each one of the individual locations.

Clause 17. The computer-implemented method according to clause 16, wherein the at least one camera comprises a first camera and a second camera, the method further comprising: obtaining, using the first camera, a first image from a first side of the storage rack; and obtaining, using the second camera, a second image from a second side of the storage rack, wherein the at least one image comprises the first image and the second image.

Clause 18. The computer-implemented method according to any of clauses 16 or 17, further comprising: rendering a user interface that displays the decoded representation in association with a representation of the individual location.

Clause 19. The computer-implemented method according to any of clauses 16-18, further comprising: identifying the storage rack based at least in part on a unique code appearing on the storage rack.

Clause 20. The computer-implemented method according to any of clauses 16-19, further comprising: in response to a selection of a user interface element, storing the decoded representation in association with the unique code and the individual location.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims. In addition, all optional and preferred features and modifications of the described embodiments and dependent claims are usable in all aspects of the disclosure taught herein. Furthermore, the individual features of the dependent claims, as well as all optional and preferred features and modifications of the described embodiments are combinable and interchangeable with one another.

The storage rack 100 and extendible rack 200 can be formed from any suitable type(s) of materials, including metal(s), metal alloy(s), plastic(s), rubber(s), ceramic(s), glass, other materials, and combinations thereof. In some cases, one or more parts can be formed as a single piece through three-dimensional (3D) printing or other additive manufacturing technique.

Because a storage rack 100 and extendible rack 200 can be configured to hold collection containers, the storage rack 100 and extendible rack 200 can also include collection containers, caps, closures, specimen tubes, vials, or other means for collecting and storing individual samples.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

1. A storage rack, comprising:
a base;
a pair of opposed ends connected to and extending upward from the base; and
two or more tiers connected to and extending between the ends, each of the tiers having a plurality of supports adapted for supporting collection containers, an upper one of the tiers having an upper stacking element formed integrally with the upper one of the tiers, a lower one of the tiers having a lower stacking element formed integrally with the lower one of the tiers, wherein the lower stacking element is adapted to be aligned with the upper stacking element of an identical storage rack when the storage rack is stacked on the identical storage rack.

2. The storage rack of claim 1, wherein each of the tiers comprises a surface adapted for displaying identifiers corresponding to the plurality of supports.

3. The storage rack of claim 1, wherein the upper stacking element is a notch that is formed integrally with at least one of the ends.

4. The storage rack of claim 1, wherein the lower stacking element is at least one tab that is formed integrally with at least one of the ends.

5. The storage rack of claim 4, wherein the at least one tab comprises two tabs that form a channel that extends along at least a portion of the at least one of the ends.

6. The storage rack of claim 1, wherein the base comprises a recessed portion adapted to receive the upper one of the tiers of the identical storage rack when the storage rack is stacked on the identical storage rack.

7. The storage rack of claim 1, wherein the plurality of supports of each of the tiers has a first side and a second side of supports.

8. The storage rack of claim 1, wherein the pair of ends are formed integrally with the base.

9. The storage rack of claim 1, wherein each one of the ends comprises an upper portion and a lower portion, the upper portion having a width that is less than the lower portion.

10. The storage rack of claim 1, wherein each of the ends further comprise a handle.

11. A system for collection container scanning, comprising:
at least one computing device; and
at least one application executed in the at least one computing device, wherein when executed the at least one application causes the at least one computing device to at least:
capture, using at least one camera, at least one image of a storage rack, the storage rack comprising two or more tiers, each of the tiers storing a plurality of collection containers at individual locations within the two or more tiers; and
determine an individual location of at least one of the plurality of collection containers based at least in part on generating a decoded representation of at least one of a plurality of identifiers appearing in the at least one image, the plurality of identifiers corresponding to each one of the individual locations.

12. The system of claim 11, wherein the at least one camera comprises a first camera configured to obtain a first image from a first side of the storage rack, and a second camera configured to obtain a second image from a second side of the storage rack, wherein the at least one image comprises the first image and the second image.

13. The system of claim 11, the at least one application further causing the computing device to render a user interface that displays the decoded representation in association with a representation of the individual location.

14. The system of claim 11, the at least one application further causing the computing device to identify the storage rack based at least in part on a unique code appearing on the storage rack.

15. The system of claim 14, the at least one application further causing the computing device to, in response to a selection of a user interface element, storing the decoded representation in association with the unique code and the individual location.

16. A computer-implemented method for collection container scanning, comprising:
capturing, using at least one camera, at least one image of a storage rack, the storage rack comprising two or more tiers, each of the tiers storing a plurality of collection containers at individual locations within the two or more tiers; and
determining an individual location of at least one of the plurality of collection containers based at least in part on generating a decoded representation of at least one of a plurality of identifiers appearing in the at least one image, the plurality of identifiers corresponding to each one of the individual locations.

17. The computer-implemented method of claim 16, wherein the at least one camera comprises a first camera and a second camera, the method further comprising:
obtaining, using the first camera, a first image from a first side of the storage rack; and
obtaining, using the second camera, a second image from a second side of the storage rack, wherein the at least one image comprises the first image and the second image.

18. The computer-implemented method of claim 16, further comprising:
rendering a user interface that displays the decoded representation in association with a representation of the individual location.

19. The computer-implemented method of claim 16, further comprising:
identifying the storage rack based at least in part on a unique code appearing on the storage rack.

20. The computer-implemented method of claim 19, further comprising:
in response to a selection of a user interface element, storing the decoded representation in association with the unique code and the individual location.
